(19) United States
(12) Patent Application Publication
(10) Pub. No.: US 2025/0164617 A1
(43) Pub. Date: May 22, 2025

(54) UP AND DOWN COUNTING FOR EFFICIENT LASER SPOT FINDING IN LiDAR

(71) Applicant: Samsung Electronics Co., Ltd., Suwon-si (KR)

(72) Inventors: Yibing Michelle WANG, Temple City, CA (US); Tze Ching FUNG, Diamond Bar, CA (US); Alfonso Cesar Barredo ALBASON, Pasadena, CA (US); Chunji WANG, Azusa, CA (US)

(21) Appl. No.: 18/406,133

(22) Filed: Jan. 6, 2024

Related U.S. Application Data
(60) Provisional application No. 63/600,630, filed on Nov. 17, 2023.

(51) Int. Cl. G01S 7/4914; G01S 7/481; G01S 7/4915; G01S 7/497; G01S 17/14

(52) U.S. Cl. CPC G01S 7/4914; G01S 7/4815; G01S 7/4915; G01S 7/497; G01S 17/14

(57) ABSTRACT

Provided are systems, methods, and apparatuses for up and down counting for efficient laser spot finding in LiDAR. In one or more examples, the systems, devices, and methods include dividing a pixel array into multiple macro blocks, a first macro block including at least a first pixel and a second pixel of the pixel array and initializing a first photon counter of the first pixel and a second photon counter of the second pixel. The systems, devices, and methods include determining an ambient photon count of the first photon counter based on performing a set number of ambient cycles with a laser transmitter off, determining a laser photon count of the first photon counter with the laser transmitter on, and using the first pixel to perform a time-of-flight measurement based on the first pixel being selected according to the ambient photon count and the laser photon count.

### CROSS-REFERENCE TO RELATED APPLICATIONS

This application claims the benefit of U.S. Provisional Patent Application Ser. No. 63/600,630, filed Nov. 17, 2023, which is incorporated by reference herein for all purposes

### TECHNICAL FIELD

The disclosure relates generally to light detection and ranging (LiDAR) systems, and more particularly to up and down counting for efficient laser spot finding in LiDAR.

### BACKGROUND

The present background section is intended to provide context only, and the disclosure of any concept in this section does not constitute an admission that said concept is prior art.

LiDAR is a remote sensing technology that uses lasers and light energy to measure distance and map objects. LiDAR may be referred to as laser scanning or three-dimensional (3-D) scanning. LiDAR systems emit their own laser pulses, which are then reflected off objects and returned to the sensor. The system measures the time it takes for the pulses to return, allowing it to create a detailed 3D map of the environment, regardless of the ambient light conditions. LiDAR works by aiming a laser at an object, measuring the speed and intensity of the reflected signal, and using the data to calculate the distance between two points. LiDAR systems include autonomous vehicle (AV) LiDAR, airborne LiDAR (e.g., mounted on a drone), topographic LiDAR that uses a near-infrared laser to map the land, bathymetric LiDAR that uses water-penetrating green light to measure the depth of water bodies and elevations of riverbeds and seafloors, differential absorption LiDAR (DIAL) that involves firing laser beams of two wavelengths, one of which is absorbed by the molecule of interest.

The above information disclosed in this Background section is only for enhancement of understanding of the background of the disclosure and therefore it may contain information that does not constitute prior art.

### SUMMARY

In various embodiments, described herein include systems, methods, and apparatuses for up and down counting for efficient laser spot finding in LiDAR. In some aspects, the techniques described herein relate to a method including: dividing a pixel array into multiple macro blocks, a first macro block including at least a first pixel and a second pixel of the pixel array; initializing a first photon counter of the first pixel and a second photon counter of the second pixel; determining an ambient photon count of the first photon counter based on performing a set number of ambient cycles with a laser transmitter off; determining a laser photon count of the first photon counter with the laser transmitter on; and using the first pixel to perform a time-of-flight measurement based on the first pixel being selected according to the ambient photon count and the laser photon count.

In some aspects, the techniques described herein relate to a method, wherein performing the time-of-flight measurement is based on: sending a signal of the first pixel to a time-to-digital converter based on the first pixel being selected as an active pixel of the first macro block; and discarding a signal of the second pixel based on the second pixel being an inactive pixel of the first macro block. In some aspects, the techniques described herein relate to a method, wherein determining the laser photon count of the first photon counter is based on performing a set number of laser cycles or the first photon counter reaching zero before completion of the set number of laser cycles.

In some aspects, the techniques described herein relate to a method, further including: stopping the second photon counter when the first photon counter reaches zero. In some aspects, the techniques described herein relate to a method, wherein a value of the second photon counter is negative when the first photon counter reaches zero. In some aspects, the techniques described herein relate to a method, further including: stopping the first photon counter and the second photon counter based on a determination that the set number of laser cycles are completed; and selecting the first pixel based on the first pixel being a default pixel of the first macro block.

In some aspects, the techniques described herein relate to a method, further including applying a sign bit of the first photon counter to indicate the first photon counter is selected as an active pixel of the first macro block based on the first photon counter reaching zero before completion of the set number of laser cycles. In some aspects, the techniques described herein relate to a method, further including inverting bits of the first photon counter based on completing the set number of ambient cycles and prior to initiating the laser photon count with the laser transmitter on.

In some aspects, the techniques described herein relate to a method, wherein inverting the bits of the first photon counter is based on a signed bitwise operation resulting in a negative value in the first photon counter. In some aspects, the techniques described herein relate to a method, wherein initializing the first photon counter of the first pixel and the second photon counter of the second pixel at a start of the set number of ambient cycles includes: configuring the first photon counter with a first non-negative integer value; and configuring the second photon counter with a second non-negative integer value different from or equal to the first non-negative integer value.

In some aspects, the techniques described herein relate to a method, wherein the first photon counter is an n-bit counter with a sign bit, n being a positive integer. In some aspects, the techniques described herein relate to a method, further including: determining an ambient photon count of the second photon counter based on performing the set number of ambient cycles with the laser transmitter off; and determining a laser photon count of the second photon counter with the laser transmitter on.

In some aspects, the techniques described herein relate to a method, wherein the pixel array is a single-photon avalanche diode (SPAD) pixel array. In some aspects, the techniques described herein relate to a method, wherein the laser transmitter is a sparse laser array transmitter that emits a sparse laser dot array. In some aspects, the techniques described herein relate to a method, wherein: the first macro block corresponds to a first laser dot of the sparse laser dot array, and a second macro block of the multiple macro blocks corresponds to a second laser dot of the sparse laser dot array. In some aspects, the techniques described herein relate to a method, further including storing at least one of the ambient photon count or the laser photon count in a memory.

In some aspects, the techniques described herein relate to a device, including: at least one memory; and at least one processor coupled with the at least one memory configured to: determine an ambient photon count of a first photon counter based on performing a set number of ambient cycles with a laser transmitter off; determine a laser photon count of the first photon counter with the laser transmitter on; and use a first pixel of a pixel array to perform a time-of-flight measurement based on the first pixel being selected according to the ambient photon count and the laser photon count.

In some aspects, the techniques described herein relate to a device, wherein the at least one processor being configured to: divide the pixel array into multiple macro blocks, a first macro block including at least the first pixel and a second pixel of the pixel array; and initialize the first photon counter of the first pixel and a second photon counter of the second pixel for the set number of ambient cycles with the laser transmitter off.

In some aspects, the techniques described herein relate to a device, wherein the at least one processor performing the time-of-flight measurement is based on the at least one processor being configured to: send a signal of the first pixel to a time-to-digital converter based on the first pixel being selected as an active pixel of the first macro block; and discard a signal of the second pixel based on the second pixel being an inactive pixel of the first macro block.

In some aspects, the techniques described herein relate to a device, wherein: the at least one processor determines the laser photon count of the first photon counter based on the at least one processor being configured to perform a set number of laser cycles or the first photon counter reaching zero before completion of the set number of laser cycles, the at least one processor stops the second photon counter when the first photon counter reaches zero, and a value of the second photon counter is negative when the first photon counter reaches zero.

A computer-readable medium is disclosed. The computer-readable medium can store instructions that, when executed by a computer, cause the computer to perform substantially the same or similar operations as described herein are further disclosed. Similarly, non-transitory computer-readable media, devices, and systems for performing substantially the same or similar operations as described herein are further disclosed.

Accordingly, the techniques described herein include multiple advantages and benefits. For example, the laser spot finding techniques described herein increase system efficiency and memory bandwidth, and decrease computational load, data throughput, and system latency. Further, in some aspects, the disclosed systems and methods divide the pixel array into macro blocks, each macro block receives one reflected laser spot. Additionally, the disclosed systems and methods select the pixels that most likely receive laser light for each macro block, and then only read data from the selected pixels. Therefore, the systems and methods described herein reduce data throughput, reduce power consumption, and simplify circuit complexity in LiDAR systems (e.g., time-of-flight LiDAR systems).

### BRIEF DESCRIPTION OF THE DRAWINGS

The above-mentioned aspects and other aspects of the present techniques will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings wherein:

FIG. 1 illustrates an example system in accordance with one or more implementations as described herein.

FIG. 2 illustrates details of the system of FIG. 1, according to one or more implementations as described herein.

FIG. 3 illustrates an example system in accordance with one or more implementations as described herein.

FIG. 4 illustrates an example system in accordance with one or more implementations as described herein.

FIG. 5 illustrates an example system in accordance with one or more implementations as described herein.

FIG. 6 depicts a flow diagram illustrating an example method associated with the disclosed systems, in accordance with example implementations described herein.

FIG. 7 depicts a flow diagram illustrating an example method associated with the disclosed systems, in accordance with example implementations described herein.

FIG. 8 depicts a flow diagram illustrating an example method associated with the disclosed systems, in accordance with example implementations described herein.

FIG. 9 depicts a flow diagram illustrating an example method associated with the disclosed systems, in accordance with example implementations described herein.

While the present techniques are susceptible to various modifications and alternative forms, specific embodiments thereof are shown by way of example in the drawings and will herein be described. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

The following description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

Please note, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Any data processing may include data buffering, aligning incoming data from multiple communication lanes, forward error correction (“FEC”), and/or others. For example, data may be first received by an analog front end (AFE), which prepares the incoming for digital processing. The digital portion (e.g., DSPs) of the transceivers may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, system-on-a-chip, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may be manifest in the form of a bit stream or other sequence of signal values electrically or optically transmitted through a medium, stored magnetic-field variations in a magnetic recording medium, etc., generated using a method and/or an apparatus as described herein.

A light detection and ranging (LiDAR) system may be configured with a high-speed Analog-to-digital converter (ADC) and/or a time-to-digital converter (TDC). The TDC may be implemented in a processing unit, such as a microcontroller, microprocessor, dedicated logic in a field-programmable gate array (FPGA), a dedicated TDC integrated circuit (IC), or another implementation. Time-Of-Flight (TOF) enables long-range and real-time LiDAR. TOF is the round-trip travel time of an optical pulse that reaches the target object and returns to the detector after being back-scattered. In some cases, TOF determines the distance between a sensor and an object either with time-resolved measurements (e.g., direct-TOF) and/or phase-resolved measurements (e.g., indirect-TOF).

Based on the TDC, time measurements are accumulated in a histogram. The histogram of a TDC indicates how frequently a time value (e.g., round trip time of an optical pulse) falls into a particular bin. The bins in a histogram are bars that represent a range of values in the data. To construct a histogram, a range of values is divided into a series of intervals called bins. The number of bins increases as the bin width decreases. A bin shift in a histogram is a change in the starting value for each bin. This shifts the data points that fall within each bin. Thus, a histogram is a chart that indicates how frequently a value falls into a particular bin, where the height of a bin corresponds to how many data points are in that bin.

Single-photon avalanche diode (SPAD) is a pixel structure in LiDAR that uses avalanche multiplication to multiply electrons from a single incident photon. A SPAD may be a solid-state photodetector within the same family as photodiodes and avalanche photodiodes (APDs). SPAD detectors provide single-photon sensitivity and allow in-pixel integration of a TDC to measure the TOF of single-photons. A SPAD sensor allows detection even when incident light is relatively weak. This low light sensitivity enables SPAD sensors to obtain a clear image even in dark places where there is relatively little light, thus enabling SPAD sensors to detect objects in the darkness. SPAD arrays are multi-pixel sensors (e.g., array of SPAD sensors), where each SPAD sensor has single-photon sensitivity and pico-second temporal resolution. This allows SPAD arrays to rapidly generate depth images with millimeter precision. In some cases, each SPAD sensor of the SPAD array operates independently and is capable of detecting individual photons. A SPAD sensor (e.g., each SPAD sensor) of the SPAD array may be used as a single point rangefinder, identifying the position of an object in the presence of ambient background illumination.

In some cases, the laser spot of a SPAD sensor illuminates only a portion of the pixel array, while all pixels are exposed to ambient illumination. A drawback of using a SPAD in a LiDAR system is its extreme sensitivity, since it gets triggered by at least one photon, with no chance to signal how many concurrent photons composed the light pulse. This causes a strong susceptibility to ambient light (i.e., background light naturally occurring in the environment, uncorrelated with the TOF illumination source), whose photons can saturate either the SPAD or the TDC conversions or even the electronics resources (e.g., TOF storage cells, digital readout speed, etc.), thus preventing the detection of just the desired signal. A SPAD sensor may be used to count photons. A LiDAR system may include one or more counters that may include at least one up counter and/or at least one down counter. An up counter is a counter circuit that counts from zero to some maximum number of counts. A down counter is a counter circuit that counts from a maximum value to zero value.

Correlated double sampling (CDS) is a signal processing technique that measures electrical values like voltages or currents. It's a common technique for sensor signal conditioning. CDS works by measuring the output of a sensor twice, once in a known condition and once in an unknown condition. The two values are then used as differential signals in further stages, such as programmable gain amplifiers (PGA) or ADC. Noise reduction circuits, such as correlated double sampling (CDS) may be employed to eliminate or reduce background noise. A CDS circuit may include one or more sample-and-hold circuits. Samples may be taken at a first stage (e.g., with the laser is off, sensing ambient only) and at a second stage (e.g., laser is on, sensing laser and ambient).

Conventional approaches include scanning LiDAR designs that perform histogram building for each pixel to guarantee no data from laser light is missed. However, such conventional approaches are burdened with a relatively large number of TDCs (e.g., TDCs shared by too many pixels), a digital block for histogram building (e.g., a digital block dedicated for histogram building), and relatively large data throughput. Thus, conventional approaches decrease system efficiency and memory bandwidth, and increase computational load, data throughput, and system latency.

The systems and methods described herein may include a scanning LiDAR system may use a sparse laser array transmitter to generate a sparse laser dot array that reduces laser optical power consumption, making the number of laser dots less than the number of pixels. A sparse optical array transmitter/receiver includes, in part, multiple optical (laser) transmitting/receiving elements (e.g., laser diodes) that are sparsely positioned. In some cases, the optical transmitting/receiving elements may be sparsely activated. For example, in a row of transmitting elements, a first subset of these transmitting elements may be activated (e.g., emitting laser pulses) while a second subset (e.g., non-overlapping subset) of these transmitting elements may be deactivated (e.g., not emitting laser pulses). Thus, the first subset of transmitting elements may emit a sparse laser dot array that is received by the receiving elements. Accordingly, the transmitting/receiving elements may not be uniformly distributed at equal distance intervals along a one-dimensional, two-dimensional, or three-dimensional array. The positions of the sparse transmitting/receiving elements may or may not conform to an ordered pattern. In some cases, the positions of the transmitting/receiving elements may be selected or activated to provide an ordered pattern.

In some cases, only a portion or a fraction of the pixels of a SPAD sensor (e.g., SPAD array) receive reflected laser light emitted by a laser transmitter (e.g., sparse laser array transmitter). However, the other pixels of the SPAD sensor may receive ambient light (e.g., only receive ambient light). Accordingly, if a system reads out data from all pixels, a majority of the readout may be wasted on ambient light data, but ambient light data does not contribute to TOF measurements.

The techniques described herein include logic (e.g., laser spot finding logic) to provide up counting and down counting for efficient laser spot finding in LiDAR. The logic includes any combination of hardware (e.g., at least one memory, at least one processor), logical circuitry, firmware, and/or software to provide the up counting and down counting for efficient laser spot finding in LiDAR. The systems and methods described herein are based on the logic described herein (e.g., laser spot finding logic). The systems and methods include dividing the pixel array into macro blocks. In some cases, a macro block (e.g., each macro block) receives a reflected laser spot per cycle. The systems and methods select one or more pixels that are determined to most likely to receive laser light for each macro block and reads out data from these selected pixels (e.g., only from these selected pixels). Accordingly, the systems and methods described herein reduce data throughput and simplify circuit complexity in a TOF LiDAR system.

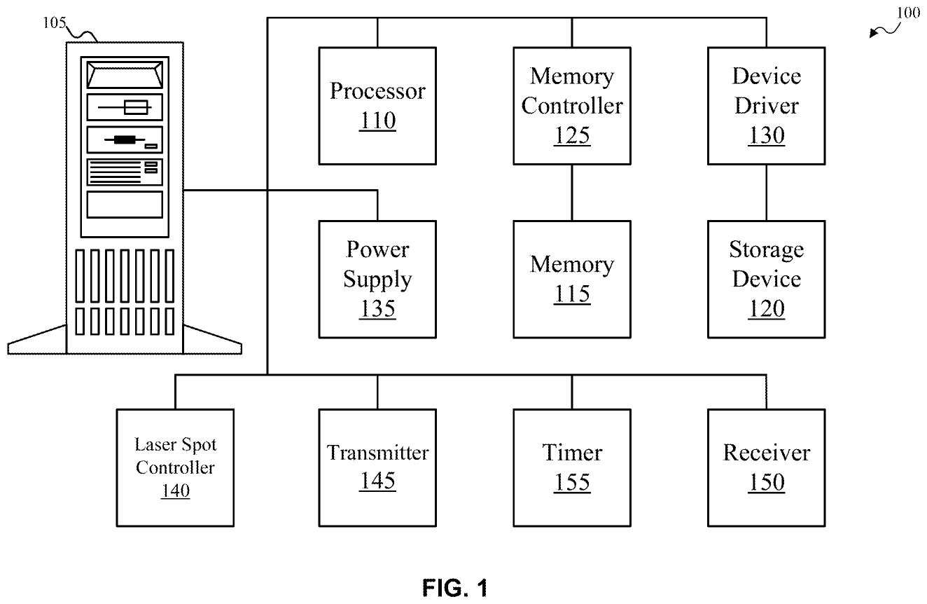

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe) interface, or a Compute Express Link (CXL) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include an optoelectronic device that converts electrical energy into light energy (e.g., laser diode). Transmitter 145 may be part of a LiDAR system and used to transmit pulses of light (e.g., laser pulse transmitter). Receiver 150 may include at least one semiconductor photodiode detector (e.g., single-photon avalanche diode (SPAD), advanced photodiode or avalanche photodiode (APD)) that uses the photoelectric effect to convert light into electricity. Thus, the receiver 150 may be used to receive a reflection of a laser pulse that is transmitted by the transmitter 145 and reflected off of an object. Thus, the transmitter 145 and receiver 150 may be used to sense a reflection of an emitted laser pulse to determine the time of flight (TOF) and distance to the reflecting object.

In the illustrated example, machine 105 may include timer 155. Timer 155 may be used in a LiDAR system. For example, timer 155 may include a time-to-digital converter (TDC). Thus, timer 155 may be used to time how long it takes for a laser pulse emitted by transmitter 145 to reflect off an object and the reflection to be detected by receiver 150.

In one or more examples, machine 105 may be implemented with any type of apparatus. Machine 105 may be configured as (e.g., as a host of) one or more of a server such as a compute server, a storage server, storage node, a network server, a supercomputer, data center system, and/or the like, or any combination thereof. Additionally, or alternatively, machine 105 may be configured as (e.g., as a host of) one or more of a computer such as a workstation, a personal computer, a tablet, a smartphone, and/or the like, or any combination thereof. Machine 105 may be implemented with any type of apparatus that may be configured as a device including, for example, a LiDAR device, an accelerator device, a storage device, a network device, a memory expansion and/or buffer device, a central processing unit (CPU), a graphics processing unit (GPU), a neural processing unit (NPU), a tensor processing unit (TPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL.mem, CXL.cache, CXL.IO and/or the like, Gen-Z, Open Coherent Accelerator Processor Interface (OpenCAPI), Cache Coherent Interconnect for Accelerators (CCIX), Advanced eXtensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

Any of the functionality described herein, including any of the host functionality, device functionally, laser spot controller 140 functionality, and/or the like, may be implemented with hardware, software, firmware, or any combination thereof including, for example, hardware and/or software combinational logic, sequential logic, timers, counters, registers, state machines, volatile memories such as dynamic random access memory (DRAM) and/or static random access memory (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application specific integrated circuits (ASICs) CPUs including complex instruction set computer (CISC) processors such as x86 processors and/or reduced instruction set computer (RISC) processors such as RISC-V and/or ARM processors), graphics processing units (GPUs), neural processing units (NPUs), tensor processing units (TPUs) and/or the like, executing instructions stored in any type of memory. In some embodiments, one or more components may be implemented as a system-on-chip (SOC).

In some examples, laser spot controller 140 may include any one or combination of logic (e.g., logical circuit), hardware (e.g., processing unit, memory, storage), software, firmware, and the like. In some cases, laser spot controller 140 may perform one or more functions in conjunction with processor 110. In some cases, at least a portion of laser spot controller 140 may be implemented in or by processor 110 and/or memory 115. The one or more logic circuits of laser spot controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable laser spot controller 140 to provide up and down counting for efficient laser spot finding in LiDAR.

In one or more examples, laser spot controller 140 provides an ambient estimation phase and a laser estimation phase to estimate respective photon counts for each phase. A laser transmitter is off during the ambient estimation cycles, and the laser transmitter is on during the laser estimation cycles. In some cases, laser spot controller 140 provides elegant and efficient counter and comparator functions to select pixels (e.g., pixels with the most difference between ambient and laser photon counts). In some cases, laser spot controller 140 divides a pixel array into two or more macro blocks, where each macro block includes two or more pixels. In some cases, laser spot controller 140 provides a sparse laser dot array to limit laser optical power consumption. A laser dot of the sparse laser dot array may be received by one of the pixels (e.g., incident upon SPAD pixels) of a macro block controlled by laser spot controller 140.

In one or more examples, laser spot controller 140 may analyze the ambient photon count of the ambient estimation phase in relation to the laser photon count of the laser estimation phase. Based on the analysis, laser spot controller 140 may select at least one pixel in a macro block (e.g., select at least one pixel per macro block, select a pixel in at least one macro block). Thus, instead of reading out data from all pixels in a given macro block, laser spot controller 140 selects one or more pixels of a macro block that are most likely to receive laser light based on the analysis.

The systems and methods of laser spot controller 140 increase system efficiency and memory bandwidth, and decrease computational load, data throughput, and system latency. Based on selecting the pixels that most likely receive laser light for each macro block, laser spot controller 140 only reads data from the selected pixels. Accordingly, laser spot controller 140 reduces data throughput, reduces power consumption, and simplifies circuit complexity of LiDAR systems.

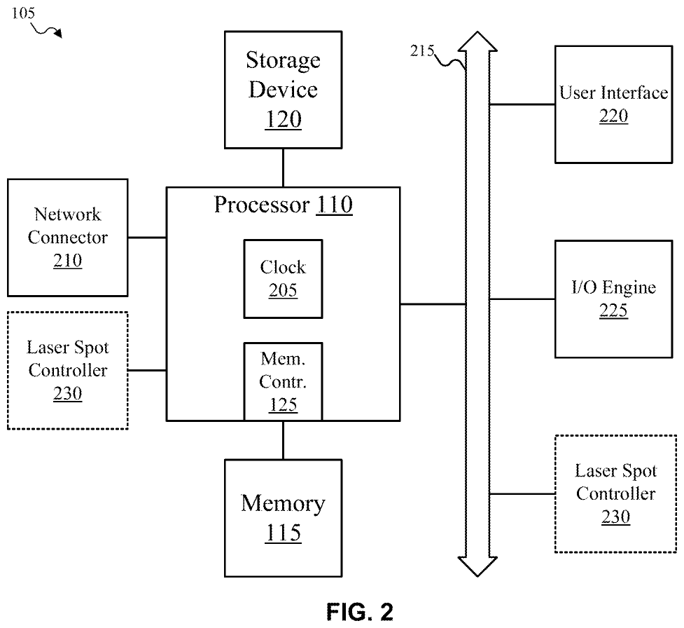

FIG. 2 illustrates details of machine 105 of FIG. 1, according to examples described herein. In FIG. 2, typically, machine 105 includes one or more processors 110, which may include memory controllers 125 and clocks 205, which may be used to coordinate the operations of the components of the machine. Processors 110 may be coupled to memories 115, which may include random access memory (RAM), read-only memory (ROM), or other state preserving media, as examples. Processors 110 may be coupled to storage devices 120, and to network connector 210, which may be, for example, an Ethernet connector or a wireless connector. Processors 110 may be connected to buses 215, to which may be attached user interfaces 220 and Input/Output (I/O) interface ports that may be managed using I/O engines 225, among other components. As shown, processors 110 may be coupled to laser spot controller 230, which may be an example of laser spot controller 140 of FIG. 1. Additionally, or alternatively, processors 110 may be connected to buses 215, to which may be attached laser spot controller 230.

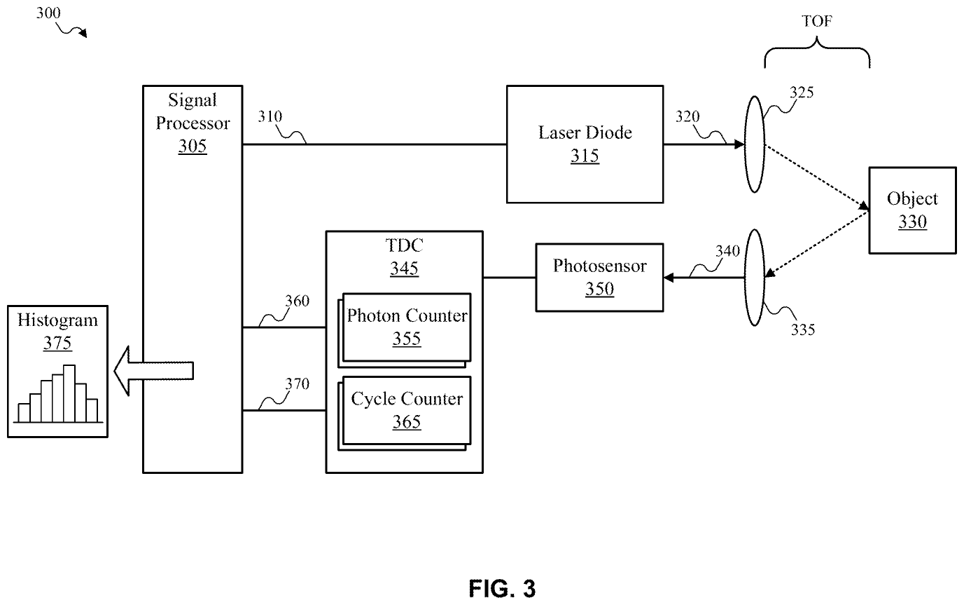

FIG. 3 illustrates an example system 300 (e.g., a LiDAR system) in accordance with one or more implementations as described herein. System 300 depicts aspects of up and down counting for efficient laser spot finding in LiDAR. One or more aspects of system 300 may be implemented by or in conjunction with laser spot controller 140 of FIG. 1 and/or laser spot controller 230 of FIG. 2.

In the illustrated example, system 300 may include signal processor 305, laser diode 315, transmitter lens 325, object 330, receiver lens 335, and at least one time-to-digital converter (TDC) 345. As shown, TDC 345 may include photosensor 350 (e.g., SPAD pixel array), at least one photon counter 355 (e.g., one photon counter per pixel of photosensor 350), and cycle counter 365 (e.g., one cycle counter per macro block of photosensor 350). Although depicted as part of or integrated with TDC 345, at least a portion of cycle counter 365 may be separate from, external to, and/or operate independent of TDC 345. In some cases, at least a portion of cycle counter 365 may be incorporated in signal processor 305. For example, signal processor 305 and cycle counter 365 may initiate and track cycles of laser pulses emitted by laser diode 315 (e.g., per macro block of photosensor 350). Examples of photosensor 350 may include an array of solid-state photodetectors, an array of photodiodes, an array of single-photon avalanche diodes (SPADs), an array of avalanche photodiodes (APDs), and the like.

In one or more examples, photon counter 355 may be an n-bit counter, where n is a positive integer. In some examples, photon counter 355 may be configured with a sign bit. In some cases, photon counter 355 may include a coarse photon counter and a fine photon counter. The fine photon counter may be based on a delayed-lock loop (DLL). A DLL is a digital circuit that equalizes the phase of two delayed copies of the same clock signal. DLLs can use integrations, filters, and numerical control oscillators (NCO) to track incoming signals.

In some examples, laser spot controller 140 and/or laser spot controller 230 may be implemented in any one or combination of signal processor 305, laser diode 315, transmitter lens 325, receiver lens 335, TDC 345, photosensor 350, and/or photon counter 355. The depicted laser diode 315 and transmitter lens 325 may be example components and/or function in conjunction with a transmitter (e.g., transmitter 145 of FIG. 1). The depicted receiver lens 335 and TDC 345 (and components thereof) may be example components and/or function in conjunction with a receiver (e.g., receiver 150 of FIG. 1).

In one or more examples, signal processor 305 initiates a cycle in conjunction with cycle counter 365 and sends a signal 310 to laser diode 315 to cause laser diode 315 to emit a light pulse 320 (e.g., a laser pulse, a reference light). The TDC 345 initiates photon counter 355 based on the emission of the light pulse 320 (e.g., at the time the light pulse 320 is emitted). The light pulse 320 is focused via transmitter lens 325 and is incident upon object 330. Reflected light 340 is captured by receiver lens 335 and detected by TDC 345 via a sensor, such as an avalanche photodiode (APD) (e.g., an APD of TDC 345). The TDC 345 determines a time of flight based on a value of the photon counter 355 at the time the reflected light 340 is detected. The photon count 360 (e.g., value of the photon counter 355) are provided to the signal processor 305. In some cases, signal processor 305 sends a signal to photon counter 355 to initiate the photon count (initialize to an offset value), to reset the photon counter, to invert the photon counter, to flip a sign bit of the photon counter 355, etc. As shown, cycle counter 365 provides a cycle count 370 to signal processor 305. In some cases, signal processor 305 sends a signal to cycle counter 365 to initiate the cycle count, to increment the cycle counter, etc. The signal processor 305 determines a readout based on the photon count 360 and records the readout in histogram 375 (e.g., assigns the readout to a bin value of histogram 375).

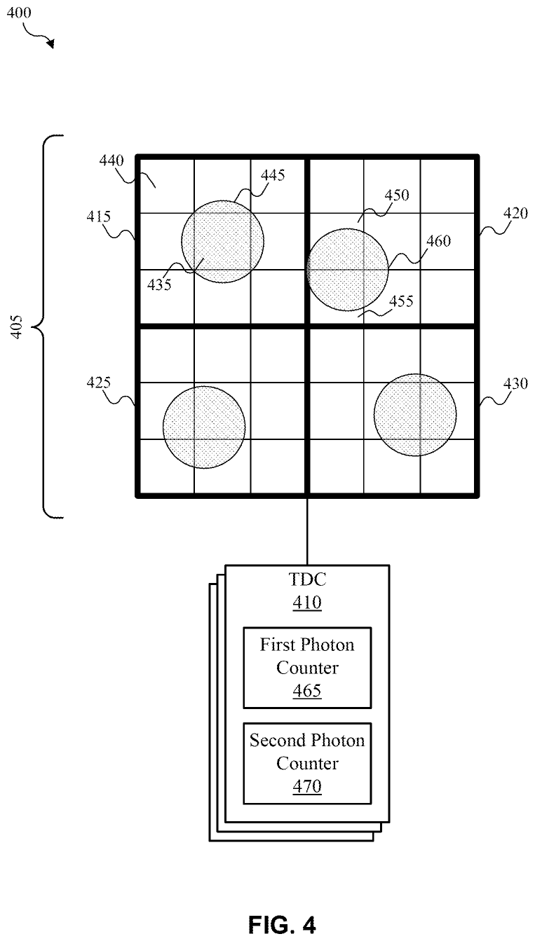

FIG. 4 illustrates an example system 400 (e.g., a LiDAR system) in accordance with one or more implementations as described herein. System 400 depicts aspects of up and down counting for efficient laser spot finding in LiDAR. One or more aspects of system 400 may be implemented by or in conjunction with laser spot controller 140 of FIG. 1, laser spot controller 230 of FIG. 2, and/or any component or combination of components of system 300 of FIG. 3.

In the illustrated example, system 400 depicts a pixel array 405 (e.g., a SPAD pixel array, a portion of a pixel array or SPAD pixel array) and TDC 410 (e.g., at least one TDC) communicatively connected to the pixel array 405. The pixel array 405 may be an example of receiver 150 of FIG. 1 and/or of photosensor 350 of FIG. 3. In some cases, TDC 410 may be an example of TDC 345 of FIG. 3.

In the illustrated example, pixel array 405 is divided into macro block 415, macro block 420, macro block 425, and macro block 430. In the illustrated example, each macro block includes nine pixels of pixel array 405 (e.g., 3×3 macro blocks). In other examples, a given pixel array may be divided into macro blocks with more or less number of pixels (e.g., 1×2, 2×1, 2×2, 2×3, 3×2, 2×4, 4×2, 3×4, 4×3, 4×4 macro blocks, etc.).

In the illustrated example, macro block 415 includes pixel 435 and pixel 440 among the pixels of macro block 415 (e.g., SPAD pixels of macro block 415). Also, macro block 420 includes pixel 450 and pixel 455 among the pixels of macro block 420 (e.g., SPAD pixels of macro block 420). As shown, each macro block is associated with a laser dot (e.g., laser spot). For example, macro block 415 is associated with laser dot 445 and macro block 420 is associated with laser dot 460. As shown, TDC 410 includes at least two photon counters (e.g., first photon counter 465 and second photon counter 470). In some cases, first photon counter 465 and/or second photon counter 470 may be examples of photon counter 355 of FIG. 3. In some examples, first photon counter 465 and/or second photon counter 470 are n-bit counters with a sign bit, n being a positive integer.

In the illustrated example, laser dot 445 falls largely on pixel 435 of macro block 415. During a laser estimation phase, system 400 may determine that pixel 435 receives the most photons of laser dot 445. Accordingly, the system 400 may select pixel 435 for time-of-flight measurements. For example, based on pixel 435 being selected for macro block 415, system 400 may provide a signal from pixel 435 to TDC 410, while discarding signals from pixel 440 and the other pixels of macro block 415 for time-of-flight measurements.

In the illustrated example, laser dot 460 falls largely on pixel 450 and pixel 455 of macro block 420. During a laser estimation phase, system 400 may determine that pixel 450 and pixel 455 receive the most photons of laser dot 460. Accordingly, the system 400 may select pixel 450 and pixel 455 for time-of-flight measurements. For example, based on pixel 450 and pixel 455 being selected for macro block 420, system 400 may provide a signal from pixel 450 and a signal from pixel 455 to TDC 410, while discarding signals from the other pixels of macro block 420 for time-of-flight measurements.

In one or more examples, signal processor 305 divides photosensor 350 (e.g., pixel array 405) into multiple macro blocks, where a first macro block includes at least a first pixel and a second pixel of the pixel array. For example, signal processor 305 divides pixel array 405 into macro block 415, macro block 420, etc. In some examples, the pixel array is a single-photon avalanche diode (SPAD) pixel array (e.g., pixel array 405).

In some cases, signal processor 305 initializes a first photon counter of the first pixel and a second photon counter of the second pixel. For example, signal processor 305 may initialize first photon counter 465 of pixel 435 and second photon counter 470 of pixel 440. In one or more examples, signal processor 305 initializes first photon counter 465 of pixel 435 and initializes second photon counter 470 of pixel 440 at a start of the set number of ambient cycles. This initialization may include signal processor 305 configuring first photon counter 465 with a first non-negative integer value and configuring second photon counter 470 with a second non-negative integer value different from or equal to the first non-negative integer value.

In one or more examples, signal processor 305 determines an ambient photon count of the first photon counter based on performing a set number of ambient cycles with a laser transmitter off. For example, signal processor 305 determines an ambient photon count of first photon counter 465 based on performing a set number of ambient cycles, where laser diode 315 does not emit laser pulses during the set number of ambient cycles and cycle counter 365 keeps track of the number of ambient cycles.

In one or more examples, signal processor 305 determines a laser photon count of the first photon counter with the laser transmitter on. For example, signal processor 305 determines a laser photon count of first photon counter 465 while laser diode 315 emits laser pulses. In one or more examples, signal processor 305 determines an ambient photon count of second photon counter 470 based on performing the set number of ambient cycles with laser diode 315 not emitting laser pulses and determines a laser photon count of second photon counter 470 with laser diode 315 emitting laser pulses. In some examples, signal processor 305 may store at least one of the ambient photon count and/or the laser photon count in a memory (e.g., memory 115).

In some examples, the laser transmitter is a sparse laser array transmitter that emits a sparse laser dot array. In some examples, macro block 415 corresponds to a first laser dot of the sparse laser dot array, macro block 420 corresponds to a second laser dot of the sparse laser dot array, macro block 425 corresponds to a third laser dot of the sparse laser dot array, and macro block 425 corresponds to a fourth laser dot of the sparse laser dot array, etc.

In one or more examples, signal processor 305 uses the first pixel to perform a time-of-flight measurement based on the first pixel being selected according to the ambient photon count and the laser photon count. For example, signal processor 305 uses a signal from pixel 435 to perform a time-of-flight measurement based on pixel 435 being selected according to the ambient photon count and the laser photon count. In some examples, performing the time-of-flight measurement is based on signal processor 305 allowing a signal of pixel 435 to be sent to TDC 410 based on pixel 435 being selected as an active pixel of macro block 415, while discarding a signal of pixel 440 based on pixel being an inactive or unselected pixel of macro block 415.

In some examples, determining the laser photon count of first photon counter 465 is based on performing a set number of laser cycles or first photon counter 465 reaching zero before completion of the set number of laser cycles (e.g., and before second photon counter 470 reaches zero). In some cases, signal processor 305 stops the second photon counter 470 when the first photon counter 465 reaches zero. For example, signal processor 305 stops each photon counter of each pixel of macro block 415 when first photon counter 465 reaches zero. In some examples, a value of the second photon counter is negative when the first photon counter reaches zero. For example, when only first photon counter 465 reaches zero, every other photon counter of the other pixels of macro block 415 is negative. In some cases, two photon counters may reach zero during the same cycle. For example, first photon counter 465 and second photon counter 470 may reach zero during the same cycle. In this case, first photon counter 465 and second photon counter 470 may be selected. Accordingly, during measurements, signals from first photon counter 465 and second photon counter 470 may be sent to TDC 410.

In one or more examples, signal processor 305 stops first photon counter 465 and second photon counter 470 based on a determination that the set number of laser cycles are completed. For example, signal processor 305 may stop every photon counter of macro block 415 when signal processor 305 determines the set number of laser cycles are completed (e.g., before any photon counter of macro block 415 reaches zero). When signal processor 305 determines that the set number of laser cycles are completed and that each photon counter of macro block 415 (e.g., including first photon counter 465 and second photon counter 470) has not reached zero (e.g., each remains negative), then signal processor 305 may select pixel 435, as one example, based on the pixel 435 being a default pixel of the macro block 415.

In one or more examples, signal processor 305 applies a sign bit of first photon counter 465 to indicate first photon counter 465 is selected as an active pixel of macro block 415 based on first photon counter 465 reaching zero before completion of the set number of laser cycles.

In one or more examples, signal processor 305 inverts bits of first photon counter 465 based on completing the set number of ambient cycles and prior to initiating the laser photon count with the laser transmitter on. For example, signal processor 305 may invert the bits of each photon counter of each macro block based on a determination that the set number of ambient cycles have completed. In some cases, signal processor 305 may invert the bits of the photon counters prior to or at the start of the laser estimation phase with laser diode 315 emitting laser pulses. In some cases, inverting the bits of first photon counter 465 is based on a signed bitwise operation resulting in a negative value in first photon counter 465. For example, first photon counter 465 may read 42 upon completion of the ambident estimation phase. Based on the signed bitwise operation that flips each bit of first photon counter 465, first photon counter 465 may then read −43. Accordingly, each photon that first photon counter 465 reads during the laser estimation phase increases the count of first photon counter 465 (e.g., from −43 to −42, from −42 to −41, until reaching zero).

Accordingly, aspects of system 300 and/or system 400 increase system efficiency and memory bandwidth, and decrease computational load, data throughput, and system latency. Aspects of system 300 and/or system 400 include dividing the pixel array 405 into macro blocks, each macro block receiving one reflected laser spot. Aspects of system 300 and/or system 400 include selecting one or more pixels that most likely receive laser light for each macro block, and then only read data from the selected pixels. Therefore, system 300 and/or system 400 reduces data throughput, reduces power consumption, and simplifies circuit complexity in LiDAR systems (e.g., time-of-flight LiDAR systems).

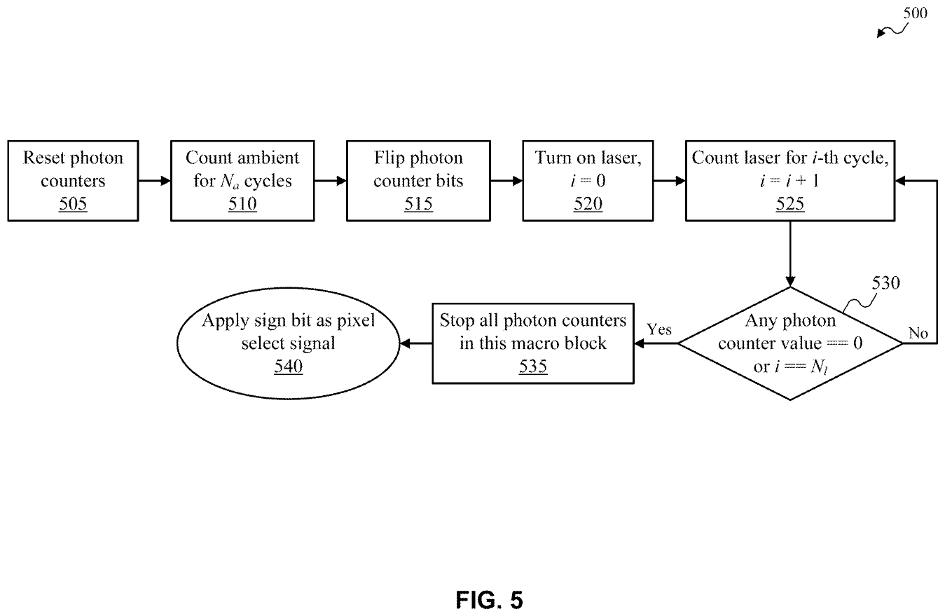

FIG. 5 depicts a flow diagram illustrating an example method 500 associated with the disclosed systems, in accordance with example implementations described herein. In some configurations, the method 500 may be implemented by laser spot controller 140 of FIG. 1, laser spot controller 230 of FIG. 2, any component or combination of components of system 300 of FIG. 3, and/or any component or combination of components of system 400 of FIG. 4. In some configurations, the method 500 may be implemented in conjunction with machine 105, components of machine 105, or any combination thereof. The method 500 is just one implementation and one or more operations of the method 500 may be rearranged, reordered, omitted, and/or otherwise modified such that other implementations are possible and contemplated.

In one or more examples, the systems and methods described herein divide a SPAD pixel array into macro blocks. In some cases, a macro block (e.g., each macro block) corresponds to one laser spot (e.g., configured to receive one laser spot per cycle). For example, the systems and methods may include dividing a pixel array into macro blocks where each macro block is configured to receive a reflected laser spot (e.g., per cycle).

In one or more examples, the systems and methods described herein may use one or more counters. The counters may include one or more photon counters (e.g., photon counter 355) and/or one or more cycle counters (e.g., cycle counter 365). In some cases, a pixel may include a photon counter (e.g., each SPAD pixel includes a photon counter).

Method 500 refers to Nₐ cycles and Nₗ cycles. Nₐ stands for the number of ambient cycles (e.g., the number of cycles with the laser off, ambient estimation phase) and Ni stands for the number of laser cycles (e.g., the number of cycles with the laser on, laser estimation phase). Examples of the number of ambient cycles and/or the number of laser cycles include 10 cycles, 50 cycles, 100 cycles, 200 cycles, etc. In some examples, one or more cycle counters (e.g., cycle counter 365) track the number of ambient cycles and the number of laser cycles. In some cases, the number of ambient cycles may equal the number of laser cycles (e.g., Nₐ=Nₗ=100 cycles). In some cases, the number of ambient cycles may differ from the number of laser cycles (e.g., Nₐ=100 cycles, Nₗ=200 cycles). In some cases, method 500 may include maintaining a number of ambient light cycles when the measured ambient light falls within a given range (e.g., between a high ambient light threshold and a low ambient light threshold). When it is determined that the level of ambient light exceeds a high ambient light threshold (e.g., the ambient light is too strong, ambient oversaturation), then method 500 may include adjusting Nₐ so that the number of ambient cycles is reduced. When it is determined that the level of ambient light drops below a low ambient light threshold (e.g., the ambient light is too low), then method 500 may include adjusting Nₐ so that the number of ambient cycles is increased. Similar adjustments may be made for the number of laser cycles Ni (e.g., independent of the number of ambient cycles).

At 502, a photon counter (e.g., photon counter of each pixel of a macro block) is reset to a non-negative integer value m (e.g., m=1, m=2, m=4, m=16, m=24, etc.). For example, at the beginning of an ambient light measurement, method 500 may include initializing a photon counter (e.g., each pixel photon counter) with the value m. Accordingly, the ambient estimation phase may begin with each photon counter of each macro block set to some offset (e.g., m=16). Thus, if a photon counter is set to a value of 16, for example, then the photon counter is increased to 17 upon detecting the first photon after initiating the ambient estimation phase. In some cases, m can be different for different pixels (e.g., a first value m1 for a first photon counter of a first pixel, a second value m2 for a second photon counter of a second pixel, where m2 is different from m1, etc.). Alternatively, method 500 may include initializing each photon counter at 0, and then set each pixel value to at least one value of m according to system settings.

At 510, method 500 may include operating a number of ambient cycles (e.g., Nₐ cycles) without the laser emitting (e.g., an ambient estimation phase tracked by cycle counter 565). Without the laser emitting, method 500 may include counting the ambient light for a given pixel (e.g., a photon counter counts the number of photons detected at a pixel of a macro block). At the end of the Nₐ cycles, method 500 may include storing the ambient photon count of a given pixel in memory (e.g., a register, static random-access memory (SRAM), memory 115, or any other type of memory).

At 515, method 500 may include flipping photon counter bits. For example, method 500 may include inverting the bits of a photon counter (e.g., inverting the bits of each photon counter of each pixel of each macro block). In some cases, method 500 may include flipping the bits of each photon counter based on bitwise complement or bitwise inversion operation that inverts each bit from 0 to 1 and from 1 to 0 (e.g., value is negative after flip based on signed bitwise inversion). For instance, the signed bitwise complement of 16 is −17, the signed bitwise complement of 24 is −25, the signed bitwise complement of 64 is −65, etc. Thus, if the value of a first photon counter is 23, then after the bits of the first photon counter are flipped, the value of the first photon counter is −24. If the value of a second photon counter is 42, then after the bits of the first photon counter are flipped, the value of the first photon counter is −43.

At 520, method 500 may include turning on a laser. For example, method 500 may include causing a laser to start emitting laser light (e.g., turn on the laser in a laser estimation phase). In some cases, method 500 may include keeping track of the number of laser cycles (e.g., initiating cycle counter 565 to i=0, incrementing cycle counter 565 each cycle).

At 525, method 500 may include counting laser photons for each cycle. In some cases, method 500 may include initiating Ni cycles with the laser emitting and tracking the laser photon count for each pixel. For example, method 500 may include photon counter 555 of a pixel of a macro block counting laser photons for each cycle (e.g., for the i-th cycle). As shown, method 500 may include incrementing the cycle count (e.g., i=i+1) at each iteration.

At 530, method 500 may include determining whether a photon counter of a pixel of a macro block has reached zero (e.g., m==0) and/or whether the number of laser cycles has reached Ni cycles (e.g., i==Ni). For example, at iteration of a cycle of the laser estimation phase, method 500 may include determining, for each macro block, whether the photon counter value of a pixel has reached zero (e.g., reaches m=0) or whether the number of laser cycles has reached Nₗ.

At 535, method 500 may include stopping counting photons for all pixels of a given macro block when at least one photon counter of a pixel of this macro block has reached zero and/or the number of laser cycles has reached Ni.

Accordingly, during the laser estimation phase, the photon counter of a pixel is increased by 1 for each photon detected. If the value of the photon counter is 120 at the conclusion of the ambient estimation phase, then based on the bitwise inversion, the value of the photon counter at the start of the laser estimation phase is −121. Each time the photon counter of a pixel detects a laser spot, the photon counter of that pixel is increased by 1. Thus, after detecting a first photon, the value of the photon counter is increased from the initial value of −121 to −120, and so on. Each photon detected by this pixel increases the value of its photon counter until the value of the photon counter reaches zero (e.g., as long as the number of laser cycles has not reached Ni or the number of laser cycles reaches Ni during the same cycle in which a photon counter of a pixel reaches zero). Thus, when the value of a photon counter reaches zero (e.g., before or by the time the laser cycles have completed), then photon counting for that pixel and all other pixels of the same macro block is stopped (e.g., photon counting for other macro blocks may continue until the same condition is met).

Accordingly, when it is determined that a photon counter value of a pixel of the macro block reaches zero (e.g., determine m=0 for the photon counter), then method 500 may include selecting this pixel of the macro block and stop counting for this macro block. Counting may continue for pixels of other macro blocks (e.g., until m=0 or the number of cycles has reached Ni for the other macro blocks).

When it is determined that the number of cycles has reached Ni (e.g., determine i=Nₗ for the cycle counter), and no pixel of a macro block has reached zero, then method 500 may include selecting at least one default pixel among the pixels of that macro block.

At 540, method 500 may include applying a sign bit as a pixel select signal. For example, after stopping the count for the macro block, method 500 may include applying the sign bit as a pixel select signal. In some examples, method 500 may include applying the sign bit of the photon counter for the pixel (e.g., one or more pixels) whose photon counter reached zero. Additionally, or alternatively, method 500 may include applying the sign bit of the photon counter for the pixel selected by default. In one or more examples, the sign bit is 1 when a photon counter reaches zero. After applying the sign bit to the photon counter that reaches zero, every bit is zero for that photon counter (e.g., while the sign bit of other pixels of that macro block remains 1). Alternatively, the sign bit is 0 when a photon counter reaches zero. After applying the sign bit to the photon counter that reaches zero, the sign bit is 1 and the other bits are zero for that photon counter (e.g., while the sign bit of other pixels of that macro block remains 0). Accordingly, the sign bit of the selected pixel distinguishes it from the other pixels of the same macro block. In some cases, two or more pixels of the same macro block are selected. For example, two or more bits of the same macro block may reach zero during the same cycle. Accordingly, the sign bits of the photon counters of the two or more selected pixels may be applied to distinguish the two or more selected pixels from the other pixels of that macro block.

After determining the selected pixels of each macro block, method 500 may include performing one or more measurements (e.g., time-of-flight measurements). Thus, method 500 may include sending signals from selected pixels to a TDC (e.g., TDC 345 of FIG. 3, TDC 410 of FIG. 4), while signals from unselected pixels are not sent to the TDC. For example, method 500 may include sending signals from one or more selected pixels of a macro block to the TDC, while signals from unselected pixels of that macro block are not sent to the TDC (e.g., signals of unselected pixels are discarded).

In some examples, after Ni laser cycles are completed for a macro block, method 500 may include continuing LiDAR operations to measure time-of-flight. In some cases, method 500 may include sending signals from (e.g., only from) selected pixels to a TDC (e.g., TDC 345 of FIG. 3, TDC 410 of FIG. 4). In some cases, method 500 may include selecting one or more default pixels of a macro block when that macro block completes Ni laser cycles (e.g., without a photon counter of that macro block reaching zero). Reaching Ni laser cycles without a photon counter of that macro block reaching zero may indicate the laser is weak, that the object reflecting laser light is far away, and/or that the object reflecting laser light is not highly reflective. For example, light from dark, dull, matte, or rough surfaces may be poor reflectors of light (e.g., because most of the light that hits them is absorbed, and little bounces back). Accordingly, method 500 may include selecting a default pixel (e.g., one or more default pixels). For example, method 500 may include selecting a pixel that is associated with light reflected from objects that are at relatively long distances. For instance, some pixels of a pixel array may be known to be associated with light reflected off of relatively near objects, some pixels of the pixel array may be known to be associated with light reflected off of objects at middle ranges, and some pixels of the pixel array may be known to be associated with light reflected off of relatively far objects. Thus, a default pixel of a given macro block may be a pixel of the pixel array that corresponds to objects at long distances.

Additionally, or alternatively, after completing Ni laser cycles, method 500 may include analyzing the ambient photon count in relation to the laser photon count for a pixel (e.g., for each pixel of that macro block) and select one or more pixels based on the analysis. For example, for a given macro block, method 500 may include selecting a pixel of the macro block that has the highest difference between the ambient photon count and the laser photon count.

Accordingly, method 500 may include dividing a SPAD pixel array into macro blocks and for each macro block, method 500 may include selecting one or more pixels of each macro block based on each macro block being configured to receive one reflected laser spot (e.g., per cycle). In some examples, method 500 includes selecting the pixels that most likely receive laser light for each macro block, and only reading out data from these selected pixels (e.g., to a TDC).

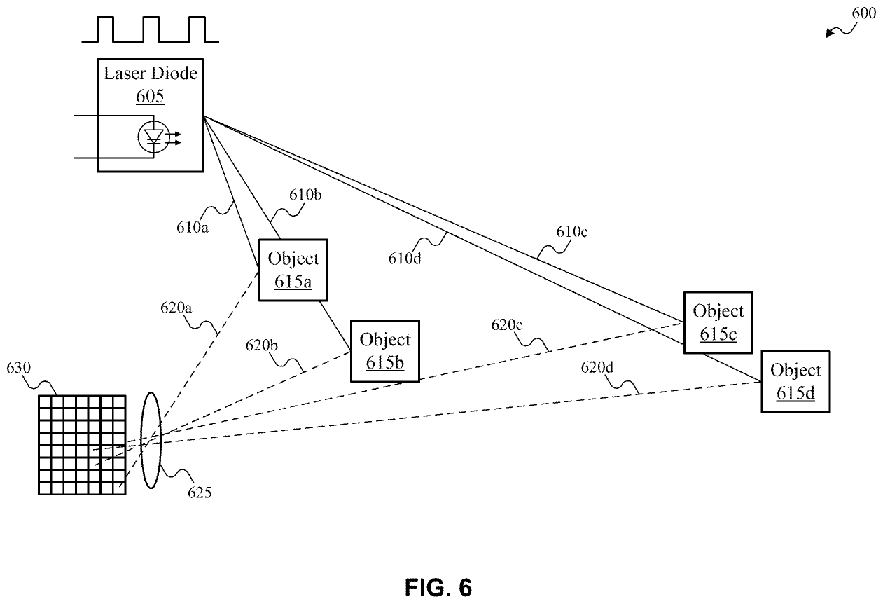

FIG. 6 illustrates an example system 600 in accordance with one or more implementations as described herein. System 600 depicts aspects of up and down counting for efficient laser spot finding in LiDAR. One or more aspects of system 600 may be implemented by or in conjunction with laser spot controller 140 of FIG. 1, laser spot controller 230 of FIG. 2, any component or combination of components of system 300 of FIG. 3, and/or any component or combination of components of system 400 of FIG. 4.

In the illustrated example, system 600 may include laser diode 605, receiver lens 625, and pixel array 630. Thus, system 600 depicts a transmitter and a receiver. As shown, the transmitter, laser diode 605, may be configured to emit optical pulses and the receiver, receiver lens 625 and pixel array 630, may be configured to detect reflections of the optical pulses, thereby detecting objects. In some cases, laser diode 605 may be an example of transmitter 145 of FIG. 1 and/or laser diode 315 of FIG. 3. In some examples, pixel array 630 may be an example of receiver 150 of FIG. 1 and/or photosensor 350 of FIG. 3. In some cases, receiver lens 625 may be an example of receiver lens 335 of FIG. 3.

In some examples, laser diode 605 may be a sparse laser array transmitter. As shown, laser diode 605 may emit laser pulses 610 in multiple directions in a given laser pulse cycle (e.g., light pulse 320 of FIG. 3). For example, laser pulse 610a may reflect off object 615a, laser pulse 610b may reflect off object 615b, laser pulse 610c may reflect off object 615c, and laser pulse 610d may reflect off object 615d. In the illustrated example, object 615b is farther than object 615a, object 615c is farther than object 615b, and object 615d is farther than object 615c.

As shown, beams of reflected light 620 (e.g., reflected light 340 of FIG. 3) may reflect off of objects 615. For example, reflected light 620a may reflect off object 615a, reflected light 620b may reflect off object 615b, reflected light 620c may reflect off object 615c, and reflected light 620d may reflect off object 615d. As shown, the beams of reflected light 620 are focused through receiver lens 625 and incident upon pixel array 630.

When an object is relatively near (e.g., object 615a), generally there will be more laser light incident upon pixel array 630 (e.g., relatively high number of reflected photons) compared to objects that are farther away. Similarly, when an object is relatively far (e.g., object 615d), there will be less laser light incident upon pixel array 630 (e.g., relatively low number of reflected photons) compared to objects that are nearer to pixel array 630 (e.g., object 615a).

In the illustrated example, disparity runs in the vertical direction in relation to pixel array 630. In some examples, the initial count offset m can depend on disparity or distance (d) of a target. Because distance or disparity determines where the laser spot lands on the macro block, the offset m can be set to be proportional to the inverse of the square of the distance to an object as follows:

$$m ∼ \frac{1}{{d}^{2}}$$

A photon counter of a pixel that is assigned a relatively high offset m means that the photon counter will reach a higher photon count in order for that pixel to be selected compared to a photon counter of a pixel with a relatively low offset m. Accordingly, objects that are relatively near pixel array 630 may be associated with relatively high m offsets, while objects that are relatively far from pixel array 630 may be associated with relatively low m offsets. Thus, for example, offset m1 used for object 615a may be higher than offset m2 used for object 615d.

As shown, system 600 depicts pixel array 630 (e.g., SPAD pixel array, grid of pixels). In the illustrated example, pixel array 630 includes 8 rows and 7 columns of pixels. Pixel array 630 may include less or more rows of pixels and/or columns of pixels than depicted. For example, pixel array 630 may be a subset of pixels of a larger pixel array. Pixel array 630 may include one or more macro blocks. For example, a macro block may include a sub-array of pixels from pixel array 630 (e.g., 1×2, 2×1, 2×2, 1×3, 3×1, 2×3, 3×2, 3×3, 2×4, 4×2, 3×4, 4×3, 4×4 macro blocks, etc.). As shown, pixels in the fourth row, sixth row, and eight row down from the top of pixel array 630 may receive a reflection of an optical pulse (e.g., reflected light 620a, reflected light 620b, etc.).

In accordance with the offset m being proportional to the inverse square of the distance to an object, object 615a detected based on laser pulse 610a reflected off of object 615a that is relatively near to pixel array 630 and, in this example, incident upon a pixel on the eighth row from the top of pixel array 630, has a higher offset m than laser pulse 610d reflected off of object 615d that is relatively far from pixel array 630 and, in this example, incident upon a pixel on the fourth row from the top of pixel array 630. Accordingly, as shown, the incident pixel on the fourth row down from the top is associated with a lower offset m1 than the offset m2 of the incident pixel on the eighth row down from the top. Thus, the incident pixel on the fourth row down from the top may have a lower light level threshold for selection based on the relatively lower offset m than the incident pixel on the eighth row down with its relatively higher offset m. As a result, the incident pixel on the fourth row down from the top would receive less incident light to be selected than the incident pixel on the eight row down from the top.

Accordingly, the systems and methods described herein include a LiDAR system that includes a sparse laser array transmitter to generate a sparse laser dot array. The LiDAR system may include a SPAD pixel array that is divided into macro blocks. The LiDAR system may include a counter for each pixel of the SPAD pixel array. The LiDAR system may include an ambient estimation phase and laser estimation phase. The LiDAR system estimates an ambient photon count and estimates a laser photon count. For each macro block, the systems and methods select one or more pixels to send signals to at least one TDC of the LiDAR system.

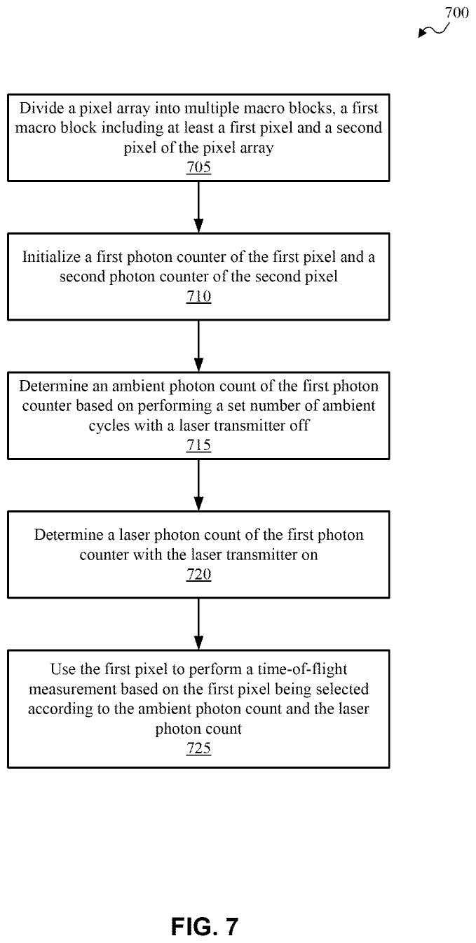

FIG. 7 depicts a flow diagram illustrating an example method 700 associated with the disclosed systems, in accordance with example implementations described herein. In some configurations, the method 700 may be implemented by laser spot controller 140 of FIG. 1, laser spot controller 230 of FIG. 2, any component or combination of components of system 300 of FIG. 3, and/or any component or combination of components of system 400 of FIG. 4. In some configurations, the method 700 may be implemented in conjunction with machine 105, components of machine 105, or any combination thereof. The method 700 is just one implementation and one or more operations of the method 700 may be rearranged, reordered, omitted, and/or otherwise modified such that other implementations are possible and contemplated.

At 705, the method 700 may include dividing a pixel array into multiple macro blocks, a first macro block including at least a first pixel and a second pixel of the pixel array. For example, laser spot controller 140 may divide pixel array 405 into macro block 415, macro block 420, etc., where macro block 415 includes pixel 435 and pixel 440.

At 710, the method 700 may include initializing a first photon counter of the first pixel and a second photon counter of the second pixel. For example, laser spot controller 140 may initialize photon counter 355 of a first pixel (e.g., pixel 435) and initialize a second photon counter of system 300 corresponding to a second pixel (e.g., pixel 440).

At 715, the method 700 may include determining an ambient photon count of the first photon counter based on performing a set number of ambient cycles with a laser transmitter off. For example, laser spot controller 140 may determine an ambient photon count of the first photon counter based on performing a set number (e.g., preset number) of ambient cycles with a laser transmitter turned off (e.g., laser diode 315 turned off).

At 720, the method 700 may include determining a laser photon count of the first photon counter with the laser transmitter on. For example, laser spot controller 140 may determine a laser photon count of the first photon counter with the laser transmitter turned on. Additionally, or alternatively, laser spot controller 140 may determine a laser photon count of the second photon counter with the laser transmitter turned on.

At 725, the method 700 may include using the first pixel to perform a time-of-flight measurement based on the first pixel being selected according to the ambient photon count and the laser photon count. For example, laser spot controller 140 may use the first pixel to perform a time-of-flight measurement based on the first pixel being selected according to the ambient photon count and the laser photon count.

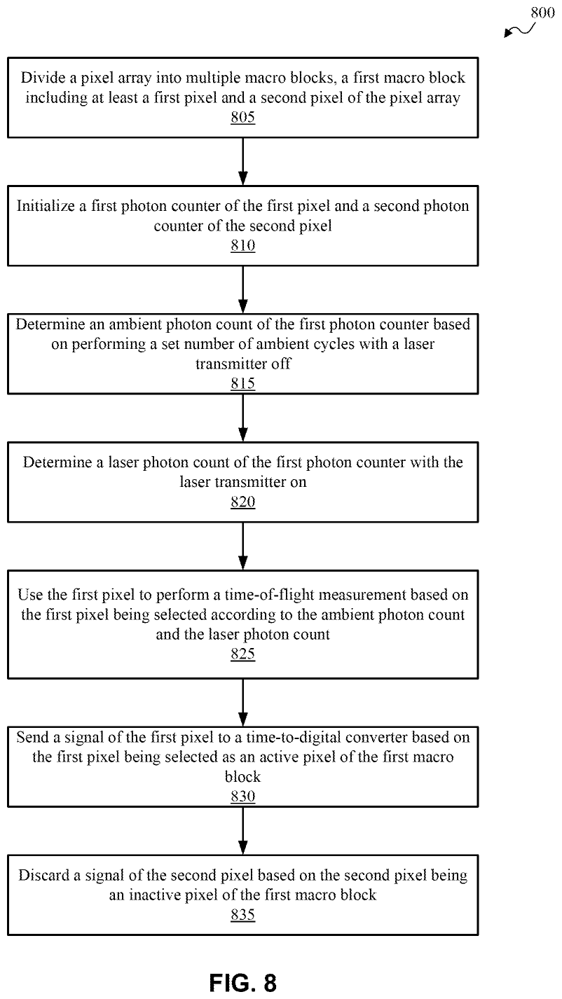

FIG. 8 depicts a flow diagram illustrating an example method 800 associated with the disclosed systems, in accordance with example implementations described herein. In some configurations, the method 800 may be implemented by laser spot controller 140 of FIG. 1, laser spot controller 230 of FIG. 2, any component or combination of components of system 300 of FIG. 3, and/or any component or combination of components of system 400 of FIG. 4. In some configurations, the method 800 may be implemented in conjunction with machine 105, components of machine 105, or any combination thereof. The method 800 is just one implementation and one or more operations of the method 800 may be rearranged, reordered, omitted, and/or otherwise modified such that other implementations are possible and contemplated.

At 805, the method 800 may include dividing a pixel array into multiple macro blocks, a first macro block including at least a first pixel and a second pixel of the pixel array. For example, laser spot controller 140 may divide pixel array 405 into macro block 415, macro block 420, etc., where macro block 415 includes pixel 435 and pixel 440.

At 810, the method 800 may include initializing a first photon counter of the first pixel and a second photon counter of the second pixel. For example, laser spot controller 140 may initialize photon counter 355 of a first pixel (e.g., pixel 435) and initialize a second photon counter of system 300 corresponding to a second pixel (e.g., pixel 440).

At 815, the method 800 may include determining an ambient photon count of the first photon counter based on performing a set number of ambient cycles with a laser transmitter off. For example, laser spot controller 140 may determine an ambient photon count of the first photon counter based on performing a set number (e.g., preset number) of ambient cycles with a laser transmitter turned off (e.g., laser diode 315 turned off).

At 820, the method 800 may include determining a laser photon count of the first photon counter with the laser transmitter on. For example, laser spot controller 140 may determine a laser photon count of the first photon counter with the laser transmitter turned on. Additionally, or alternatively, laser spot controller 140 may determine a laser photon count of the second photon counter with the laser transmitter turned on.

At 825, the method 800 may include using the first pixel to perform a time-of-flight measurement based on the first pixel being selected according to the ambient photon count and the laser photon count. For example, laser spot controller 140 may use the first pixel to perform a time-of-flight measurement based on the first pixel being selected according to the ambient photon count and the laser photon count.

At 830, the method 800 may include sending a signal of the first pixel to a time-to-digital converter based on the first pixel being selected as an active pixel of the first macro block. For example, laser spot controller 140 may send a signal of the first pixel to a time-to-digital converter (e.g., TDC 345 of FIG. 3, TDC 410 of FIG. 4) based on the first pixel being selected as an active pixel of the first macro block.

At 835, the method 800 may include discarding a signal of the second pixel based on the second pixel being an inactive pixel of the first macro block. For instance, the second pixel may still detect light during a measurement, but the second pixel may be inactive in the sense of not being used for the measurement. For example, laser spot controller 140 may not select the second pixel based on the ambient photon count and the laser photon count (e.g., of the second photon counter of the second pixel). For example, laser spot controller 140 may not select the second pixel based on the first photon counter of the first pixel reaching zero before the second photon counter of the second pixel (e.g., while the second photon counter is still negative). Accordingly, laser spot controller 140 may discard a signal of the second pixel based on the second pixel being an unselected or inactive pixel of the first macro block.

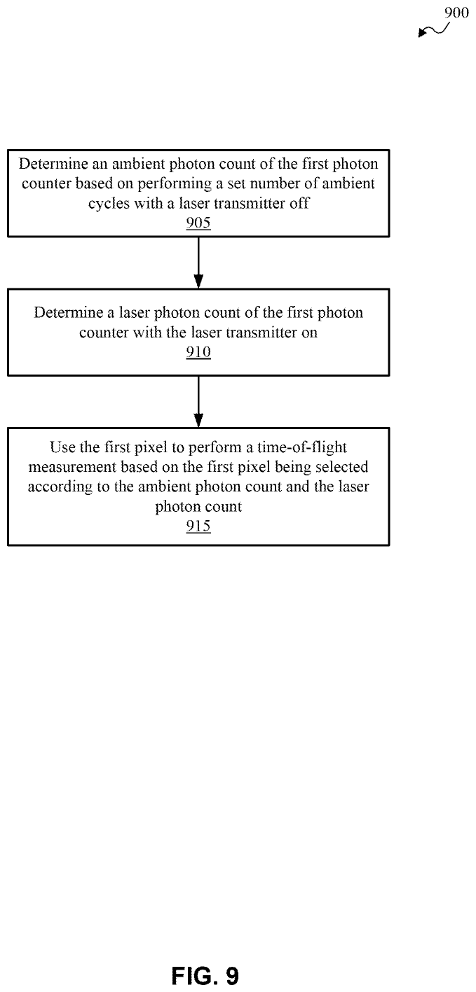

FIG. 9 depicts a flow diagram illustrating an example method 900 associated with the disclosed systems, in accordance with example implementations described herein. In some configurations, the method 900 may be implemented by laser spot controller 140 of FIG. 1, laser spot controller 230 of FIG. 2, any component or combination of components of system 300 of FIG. 3, and/or any component or combination of components of system 400 of FIG. 4. In some configurations, the method 900 may be implemented in conjunction with machine 105, components of machine 105, or any combination thereof. The method 900 is just one implementation and one or more operations of the method 900 may be rearranged, reordered, omitted, and/or otherwise modified such that other implementations are possible and contemplated.

At 905, the method 900 may include determining an ambient photon count of a first photon counter based on performing a set number of ambient cycles with a laser transmitter off. For example, laser spot controller 140 may determine an ambient photon count of the first photon counter based on performing a set number (e.g., preset number) of ambient cycles with a laser transmitter turned off (e.g., laser diode 315 turned off).

At 910, the method 900 may include determining a laser photon count of the first photon counter with the laser transmitter on. For example, laser spot controller 140 may determine a laser photon count of the first photon counter with the laser transmitter turned on. Additionally, or alternatively, laser spot controller 140 may determine a laser photon count of the second photon counter with the laser transmitter turned on.

At 915, the method 900 may include using a first pixel to perform a time-of-flight measurement based on the first pixel being selected according to the ambient photon count and the laser photon count. For example, laser spot controller 140 may use the first pixel to perform a time-of-flight measurement based on the first pixel being selected according to the ambient photon count and the laser photon count.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example an FPGA (field programmable gate array) or an ASIC (application-specific integrated circuit). The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example a CRT (cathode ray tube) or LCD (liquid crystal display) monitor, for displaying information/data to the user and a keyboard and a pointing device, for example a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example as an information/data server, or that includes a middleware component, for example an application server, or that includes a front-end component, for example a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example an HTML page) to a client device (for example for purposes of displaying information/data to and receiving user input from a user interacting with the client device). Information/data generated at the client device (for example a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples described herein set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
dividing a pixel array into multiple macro blocks, a first macro block including at least a first pixel and a second pixel of the pixel array;
initializing a first photon counter of the first pixel and a second photon counter of the second pixel;
determining an ambient photon count of the first photon counter based on performing a set number of ambient cycles with a laser transmitter off;
determining a laser photon count of the first photon counter with the laser transmitter on; and
using the first pixel to perform a time-of-flight measurement based on the first pixel being selected according to the ambient photon count and the laser photon count.

2. The method of claim 1, wherein performing the time-of-flight measurement is based on:
sending a signal of the first pixel to a time-to-digital converter based on the first pixel being selected as an active pixel of the first macro block; and
discarding a signal of the second pixel based on the second pixel being an inactive pixel of the first macro block.

3. The method of claim 1, wherein determining the laser photon count of the first photon counter is based on performing a set number of laser cycles or the first photon counter reaching zero before completion of the set number of laser cycles.

4. The method of claim 3, further comprising:
stopping the second photon counter when the first photon counter reaches zero.

5. The method of claim 3, wherein a value of the second photon counter is negative when the first photon counter reaches zero.

6. The method of claim 3, further comprising:
stopping the first photon counter and the second photon counter based on a determination that the set number of laser cycles are completed; and
selecting the first pixel based on the first pixel being a default pixel of the first macro block.

7. The method of claim 3, further comprising applying a sign bit of the first photon counter to indicate the first photon counter is selected as an active pixel of the first macro block based on the first photon counter reaching zero before completion of the set number of laser cycles.

8. The method of claim 1, further comprising inverting bits of the first photon counter based on completing the set number of ambient cycles and prior to initiating the laser photon count with the laser transmitter on.

9. The method of claim 8, wherein inverting the bits of the first photon counter is based on a signed bitwise operation resulting in a negative value in the first photon counter.

10. The method of claim 1, wherein initializing the first photon counter of the first pixel and the second photon counter of the second pixel at a start of the set number of ambient cycles comprises:
configuring the first photon counter with a first non-negative integer value; and
configuring the second photon counter with a second non-negative integer value different from or equal to the first non-negative integer value.

11. The method of claim 1, wherein the first photon counter is an n-bit counter with a sign bit, n being a positive integer.

12. The method of claim 1, further comprising:
determining an ambient photon count of the second photon counter based on performing the set number of ambient cycles with the laser transmitter off; and
determining a laser photon count of the second photon counter with the laser transmitter on.

13. The method of claim 1, wherein the pixel array is a single-photon avalanche diode (SPAD) pixel array.

14. The method of claim 1, wherein the laser transmitter is a sparse laser array transmitter that emits a sparse laser dot array.

15. The method of claim 14, wherein:
the first macro block corresponds to a first laser dot of the sparse laser dot array, and
a second macro block of the multiple macro blocks corresponds to a second laser dot of the sparse laser dot array.

16. The method of claim 1, further comprising storing at least one of the ambient photon count or the laser photon count in a memory.

17. A device, comprising:
at least one memory; and
at least one processor coupled with the at least one memory configured to:
determine an ambient photon count of a first photon counter based on performing a set number of ambient cycles with a laser transmitter off;
determine a laser photon count of the first photon counter with the laser transmitter on; and
use a first pixel of a pixel array to perform a time-of-flight measurement based on the first pixel being selected according to the ambient photon count and the laser photon count.

18. The device of claim 17, wherein the at least one processor being configured to:
divide the pixel array into multiple macro blocks, a first macro block including at least the first pixel and a second pixel of the pixel array; and
initialize the first photon counter of the first pixel and a second photon counter of the second pixel for the set number of ambient cycles with the laser transmitter off.

19. The device of claim 18, wherein the at least one processor performing the time-of-flight measurement is based on the at least one processor being configured to:
send a signal of the first pixel to a time-to-digital converter based on the first pixel being selected as an active pixel of the first macro block; and
discard a signal of the second pixel based on the second pixel being an inactive pixel of the first macro block.

20. The device of claim 18, wherein:
the at least one processor determines the laser photon count of the first photon counter based on the at least one processor being configured to perform a set number of laser cycles or the first photon counter reaching zero before completion of the set number of laser cycles,
the at least one processor stops the second photon counter when the first photon counter reaches zero, and
a value of the second photon counter is negative when the first photon counter reaches zero.
